(19) United States
(12) Patent Application Publication
(10) Pub. No.: US 2025/0313203 A1
(43) Pub. Date: Oct. 9, 2025

(54) DEVICE AND METHOD FOR CONTROLLING VEHICLE DRIVING

(71) Applicant: HL KLEMOVE CORP., Incheon (KR)

(72) Inventor: Ho-Seok SEO, Incheon (KR)

(21) Appl. No.: 18/954,499

(22) Filed: Nov. 20, 2024

(30) Foreign Application Priority Data
Apr. 4, 2024 (KR) 10-2024-0045861

(51) Int. Cl. B60W 30/16; B60W 30/18

(52) U.S. Cl. CPC B60W 30/16; B60W 30/18163; B60W 2552/10; B60W 2556/40; B60W 2556/50; B60W 2720/10

(57) ABSTRACT

Provided is a vehicle driving control device, comprising a plurality of sensors configured to obtain surrounding information about a vehicle, an information obtainer configured to obtain area information about a defensive driving area during adaptive cruise control (ACC) of the vehicle, and a controller configured to control at least one of a velocity of the vehicle and a driving route of the vehicle based on at least one of the surrounding information and the area information.

### CROSS-REFERENCE TO RELATED APPLICATION

This application claims priority from Korean Patent Application No. 10-2024-0045861, filed on Apr. 4, 2024, which is hereby incorporated by reference for all purposes as if fully set forth herein.

### BACKGROUND

### Field

The disclosure relates to controlling a vehicle and, specifically, to a device and method for controlling the driving of a vehicle during adaptive cruise control (ACC).

### Description of Related Art

The adaptive cruise control (ACC) system is a system that selects the vehicle in front as a control target using vehicle detection information detected from sensors, and automatically controls the driving velocity and inter-vehicle distance through acceleration/deceleration control and may significantly reduce the burden on the driver while driving.

The ACC system is performance-optimized based on normalized traffic flow. However, in certain areas, various situations may occur even when the ACC system operates normally depending on the traffic flow, and a specific design is required to enable safer ACC driving in preparation for such situations.

### SUMMARY

The disclosure seeks to provide a device and method capable of controlling the driving of a vehicle more safely when a vehicle in adaptive cruise control driving enters a defensive driving area requiring safer driving.

In an aspect, there is provided a vehicle driving control device, comprising a plurality of sensors configured to obtain surrounding information about a vehicle, an information obtainer configured to obtain area information about a defensive driving area during adaptive cruise control (ACC) of the vehicle, and a controller configured to control at least one of a velocity of the vehicle and a driving route of the vehicle based on at least one of the surrounding information and the area information.

In another aspect, there is provided a vehicle driving control method, comprising obtaining surrounding information about a vehicle, obtaining area information about a defensive driving area during adaptive cruise control (ACC) of the vehicle, and controlling at least one of a velocity of the vehicle and a driving route of the vehicle based on at least one of the surrounding information and the area information.

The disclosure provides a device and method capable of controlling the driving of a vehicle more safely when a vehicle in adaptive cruise control driving enters a defensive driving area requiring safer driving.

The disclosure may provide safe driving considering Safety of The Intended Functionality (SOTIF) to prepare for situations that may occur even during normal operation of the ACC system through active defensive driving.

### BRIEF DESCRIPTION OF THE DRAWINGS

The above and other objects, features, and advantages of the present disclosure will be more clearly understood from the following detailed description, taken in conjunction with the accompanying drawings, in which:

FIG. 1 is a block diagram illustrating a vehicle driving control device according to an embodiment;

FIG. 2 is a block diagram illustrating a vehicle driving control system according to an embodiment;

FIGS. 3 to 5 are views illustrating control of vehicle driving at a lane merge point or a lane diverge point according to an embodiment;

FIGS. 6 and 7 are views illustrating control of vehicle driving in a multi-lane section according to an embodiment;

FIGS. 8 and 9 are views illustrating control of vehicle driving when a lateral vehicle is present in a multi-lane section according to an embodiment; and

FIG. 10 is a flowchart illustrating a vehicle driving control method according to an embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

In the disclosure, “surrounding vehicle” means a vehicle within a predetermined range from the host vehicle, such as a preceding vehicle, a lateral vehicle, or a following vehicle. “Surrounding information” means information regarding the surroundings of the host vehicle, such as surrounding vehicle information, such as recognition of the surrounding vehicle, relative location and relative velocity, image information about the surroundings of the host vehicle. “Defensive driving area” means an area preset or determined to requires separate control for defensive driving during ACC driving.

The disclosure assumes an adaptive cruise control (ACC) system, but may also be applied to various driving systems assuming the function of the ACC system such as smart cruise control (SCC) systems unless contradictory to the technical spirit. Further, the disclosure may also be applied to the autonomous driving mode of the autonomous vehicle within an applicable range.

Hereinafter, a vehicle driving control device and method according to embodiments of the disclosure is described with the accompanying drawings.

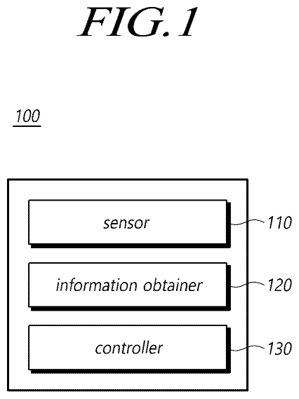

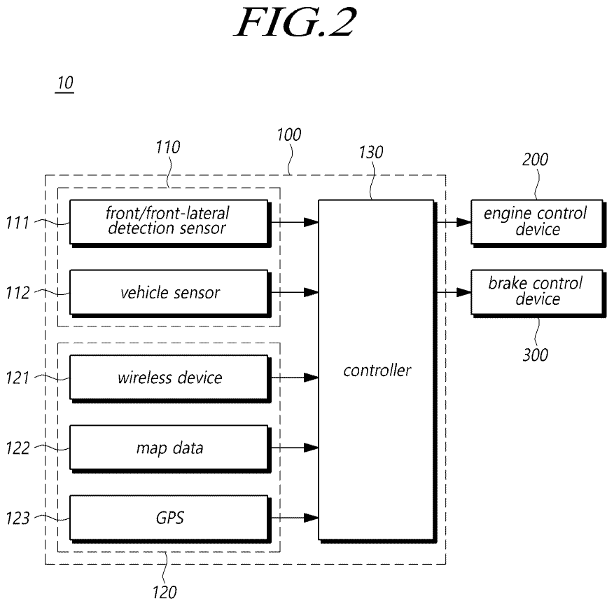

FIG. 1 is a block diagram illustrating a vehicle driving control device 100 according to an embodiment. FIG. 2 is a block diagram illustrating a vehicle driving control system 10 according to an embodiment.

Referring to FIG. 1, a vehicle driving control device 100 may include a plurality of sensors 110 obtaining surrounding area information about a vehicle, an information obtainer 120 obtaining area information about a defensive driving area during adaptive cruise control (ACC) of the vehicle, and a controller 130 controlling at least one of a velocity of the vehicle and a driving route of the vehicle based on at least one of the surrounding area information and the area information.

As illustrated in FIG. 2, the plurality of sensors 110 may include a front/front-lateral detection sensor 111 and a vehicle sensor 112. However, this is merely an example, and the disclosure is not limited thereto, and if necessary, the plurality of sensors 110 may further include a rear sensor or a rear-lateral sensor.

The plurality of sensors 110 may detect another vehicle located in the front including a preceding vehicle that is a target of ACC driving through the front/front-lateral detection sensor 111. Further, the plurality of sensors 110 may detect another vehicle located on the side of the host vehicle through the front/front-lateral detection sensor 111. Further, the plurality of sensors 110 may obtain a surrounding image such as a front side or a lateral side of the host vehicle through the front/front-lateral detection sensor 111.

According to an example, the front/front-lateral detection sensor 111 may include at least one of a camera, a radar, or a lidar for obtaining the surrounding information about a vehicle or the like located around the host vehicle. However, this is merely an example, and if surrounding information may be obtained, it is not limited to a specific sensor.

The plurality of sensors 110 may obtain host vehicle information including the velocity, acceleration, torque, or the like of the host vehicle through the vehicle sensor 112.

The plurality of sensors 110 may output the obtained surrounding information and host vehicle information to the controller 130.

When the ACC system of the vehicle is activated and driving, the information obtainer 120 may include a wireless device 121, a map data storage device 122, and a GPS device 123, as illustrated in FIG. 2, to obtain area information about the area requiring defensive driving.

According to an embodiment, the area information about the defense driving area may include information about an area including a lane merge point, a lane diverge point, a tunnel entry point, a tunnel exit point, a road widen point, a road narrow point, or a section including a predetermined number of lanes or more. However, this is merely an example, and the description of the disclosure may be substantially identically applied to an area including road sections having various structures in which an accident may occur during ACC driving, unless it contradicts the technical spirit. Further, according to an example, in addition to the structure of the road, an area requiring defensive driving, such as an accident-prone section, etc., may be included in the defensive driving area.

According to an example, the information obtainer 120 may obtain area information through communication from an external device. To that end, the information obtainer 120 may include a wireless device 121. For example, the area information about the defensive driving area may be obtained from communication with surrounding vehicles, infrastructure facilities on the driving route, a server of a road management entity, or the like.

According to another example, the information obtainer 120 may obtain area information based on map data and GPS information. The information obtainer 120 may obtain area information according to the location of the host vehicle based on the GPS value and the map data obtained from the GPS device.

The obtained area information about the defensive driving area may be stored in association with the map data. Further, the area information obtained by the information obtainer 120 may be output to the controller 130.

The controller 130 may include at least one processor and a memory communicatively coupled to the processor. In this case, the memory may store instructions and data for the controller 130 to perform the embodiments according to the disclosure. According to an example, the processor may include a micro control unit (MCU). The memory may include not only volatile memories such as S-RAM and D-RAM, but also non-volatile memories such as flash memory, read only memory (ROM), and erasable programmable read only memory (EPROM).

According to an example, the controller 130 may receive area information about the defensive driving area from the information obtainer 120.

Further, according to another example, the controller 130 may recognize the traffic sign from the surrounding information received from the plurality of sensors 110, and obtain the area information about the defensive driving area based on the traffic sign. In other words, the controller 130 may recognize the traffic sign from the image around the host vehicle included in the surrounding information, and determine the type or displayed content of the traffic sign. According to an example, after the operation of recognizing and determining the traffic sign in the surrounding image, the controller 130 may determine whether the area to be driven corresponds to the defensive driving area according to the type or displayed content of the traffic sign.

The controller 130 may determine whether to enter the defensive driving area when driving along the currently set driving route during ACC driving based on the area information. According to an example, when the host vehicle enters within a predetermined distance range from the defense driving area, the controller 130 may determine the defense driving to control the velocity or driving route of the vehicle. Alternatively, when the controller 130 reaches within the predetermined time range before entering the defensive driving area considering the velocity of the vehicle, the controller 130 may determine the defensive driving to control the velocity or driving route of the vehicle.

Further, the controller 130 may determine the defensive driving based on the surrounding information to control the velocity of the vehicle or the driving route of the vehicle. According to an example, when the surrounding vehicle is driving on a side of the vehicle in the defensive driving area, the controller 130 may control the velocity of the vehicle to secure a safety space on the side of the vehicle. Alternatively, the controller 130 may determine the defensive driving when the surrounding vehicle is driving together on the side of the vehicle for a predetermined time or more, even when it is not the defensive safety area.

When the controller 130 determines the defensive driving, the controller 130 may determine the velocity of the vehicle to be changed or the driving route of the vehicle, and control the engine control device 200 and the brake control device 300 to change the velocity of the vehicle or the driving route of the vehicle. The detailed operation of the controller 130 is described below in more detail with reference to the relevant drawings.

For the above-described operation, the vehicle control device 100 may perform communication internally or externally through a vehicle communication network. For example, an interface such as ethernet, media oriented systems transport (MOST), Flexray, controller area network (CAN), or local interconnect network (LIN) may be used to exchange data. For example, the vehicle control device 100 may transmit a driving control signal, a braking signal, and a steering signal to the engine control device 200, the brake control device 300, and an electronic steering device (not shown), respectively, through the vehicle communication network.

Accordingly, when a vehicle in adaptive cruise control driving enters a defensive driving area requiring safer driving, it is possible to control the driving of the vehicle more safely, and to prepare for a situation that may occur even when the ACC system is operating normally through active defensive driving.

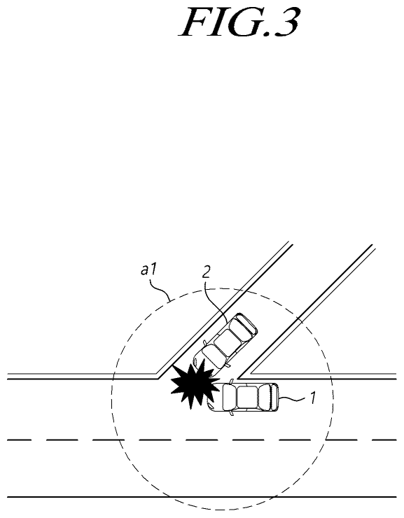

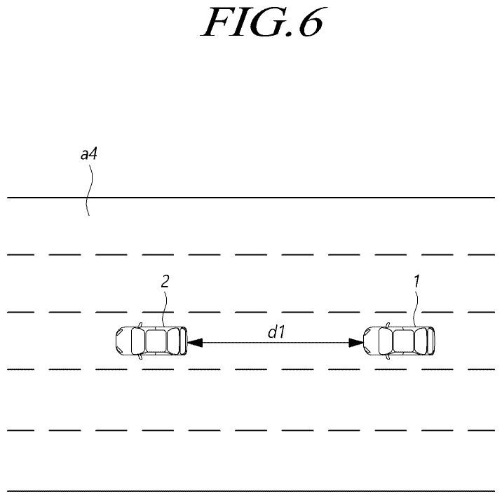

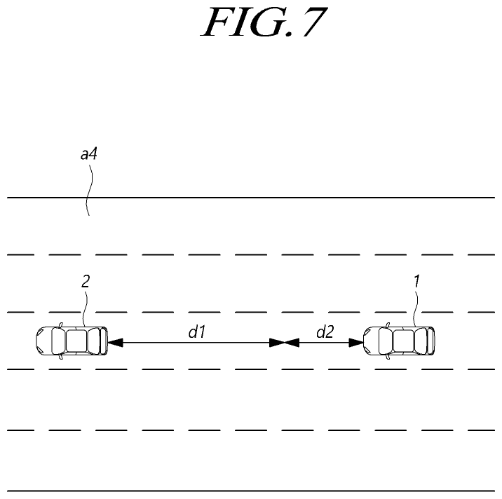

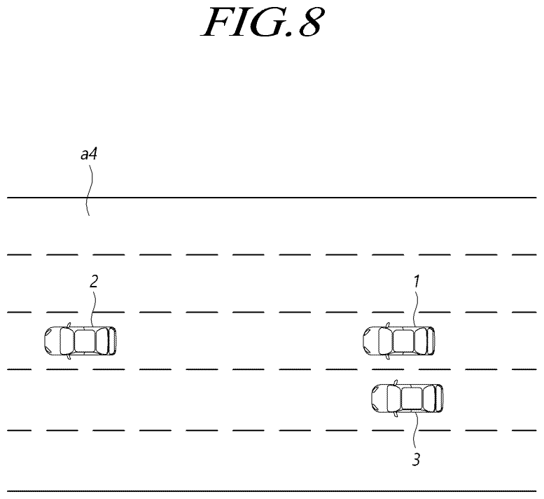

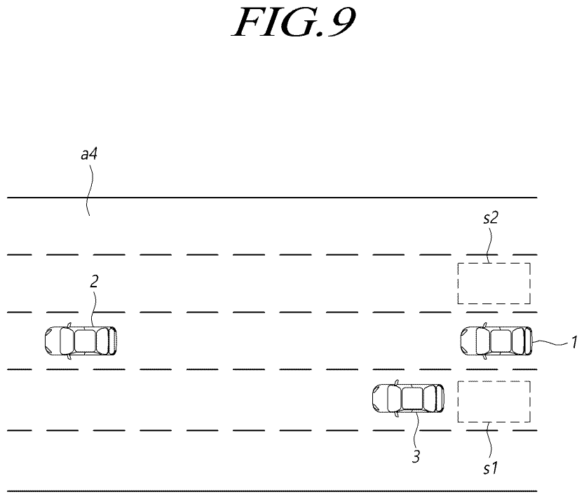

FIGS. 3 to 5 are views illustrating control of vehicle driving at a lane merge point or a lane diverge point according to an embodiment. FIGS. 6 and 7 are views illustrating control of vehicle driving in a multi-lane section according to an embodiment. FIGS. 8 and 9 are views illustrating control of vehicle driving when a lateral vehicle is present in a multi-lane section according to an embodiment.

The controller 130 may control the velocity of the vehicle to secure the maximum safe distance according to adaptive cruise control in the defensive driving area based on the area information. Alternatively, the controller 130 may control the velocity of the vehicle to further secure an additional distance to the maximum safe distance. Further, the controller 130 may change the driving lane of the vehicle when entering the defensive driving area based on the area information. The velocity control of the vehicle and the driving route control for changing the driving lane may be performed each depending on the situation, or both may be performed simultaneously.

Referring to FIG. 3, a defensive driving area a1 including a lane merge point is illustrated. In the case of the lane merge point, an accident may occur as another vehicle 2 enters from the joining lane, and thus it may be set as a defensive driving area.

In this case, if it is determined that the vehicle enters the defensive driving area a1 during ACC driving, the controller 130 may control the velocity of the vehicle to maintain the maximum safe distance from the preceding vehicle settable in the ACC system. For example, it is assumed that the safe distance from the preceding vehicle settable during ACC driving is up to 100 m, and the current safe distance is maintained as 50 m. In this case, the controller 130 may reduce the velocity of the vehicle to maintain the safe distance as 100 m while passing through the section including the defensive driving area a1.

Alternatively, if it is determined that the vehicle enters the defensive driving area a1 during ACC driving, the controller 130 may control the velocity of the vehicle to further secure an additional distance to the maximum safe distance. Securing the additional distance may be set without a separate condition or, when a separate condition is met, such as when a surrounding vehicle is present around the host vehicle, may be triggered. For example, it is assumed that the safe distance from the preceding vehicle settable during ACC driving is up to 100 m, the additional distance is 20 m, and the current safe distance is maintained as 50 m. Further, it is assumed that the trigger condition is the presence of a lateral vehicle in a lane immediately next to the driving route of the vehicle. In this case, if the lateral vehicle is detected while passing through the section including the defensive driving area a1, the controller 130 may reduce the velocity of the vehicle to maintain the safe distance as 120 m.

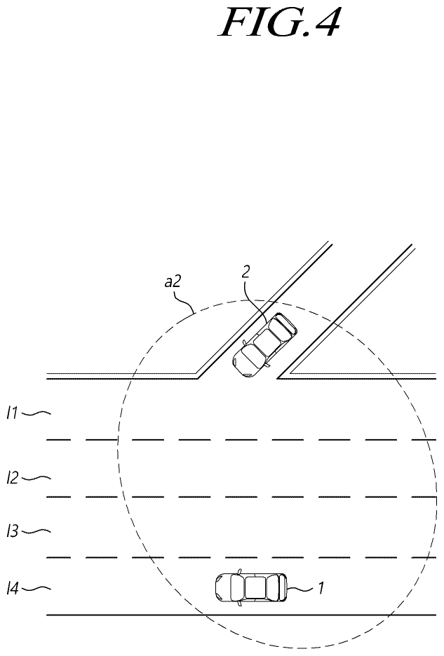

Referring to FIG. 4, a defensive driving area a2 including a lane merge point and a section including a predetermined number of lanes or more is illustrated. In this case, an accident may occur as the other vehicle 2 enters from the joining lane, and when the other vehicle 2 joins the lane, the other vehicle 2 may enter the lanes 12 to 14 rather than the lane 11, and thus, it may be set as a defensive driving area. In FIG. 4, the predetermined number is illustrated as four, but this is merely an example, and the disclosure is not limited thereto.

In this case, the controller 130 may change the driving lane of the vehicle when entering the defensive driving area a2 based on the area information. When the defensive driving area a2 includes a lane merge point, the controller 130 may change the driving lane of the vehicle to the lane 12, 13, or 14 rather than the lane 11 where the other lanes merges. For example, referring to FIG. 4, it is assumed that the host vehicle 1 is ACC-driving in the lane 11 where another lane merges. In this case, the controller 130 may control the driving route to sequentially change the driving lane to the other lanes 12, 13, and 14 while passing through the section including the defensive driving area a2.

According to an example, when the defensive driving area includes a lane merge point, the controller 130 may output a lane change proposal to a lane other than the lane where the other lane merges. In other words, even when the change of the driving lane is determined according to the defensive driving area, the controller 130 may output the lane change proposal through an in-vehicle output device rather than immediately changing the lane. Accordingly, it is possible to prevent an influence that may be had on the driver due to an unintended lane change during ACC driving.

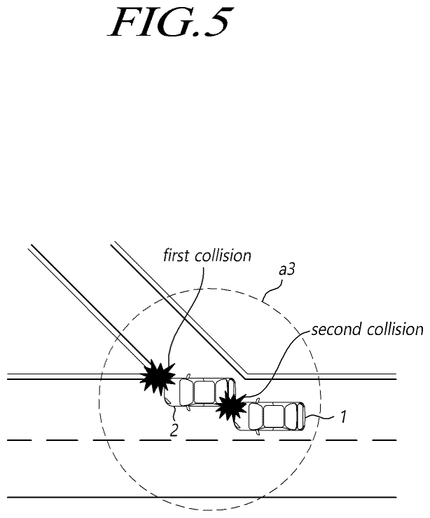

Referring to FIG. 5, a defensive driving area a3 including a lane diverge point is illustrated. In the case of the lane diverge point, an accident may occur as another vehicle 2 exits to the branching lane, and thus it may be set as a defensive driving area. In other words, as illustrated in FIG. 5, there may be a risk of collision with the host vehicle 1 of the other vehicle 2 wrong entering the branching lane.

In this case, if it is determined that the vehicle enters the defensive driving area a3 during ACC driving, the controller 130 may control the velocity of the vehicle to maintain the maximum safe distance from the preceding vehicle settable in the ACC system. For example, it is assumed that the safe distance from the preceding vehicle settable during ACC driving is up to 100 m, and the current safe distance is maintained as 50 m. In this case, the controller 130 may reduce the velocity of the vehicle to maintain the safe distance as 100 m while passing through the section including the defensive driving area a3.

Alternatively, if it is determined that the vehicle enters the defensive driving area a3 during ACC driving, the controller 130 may control the velocity of the vehicle to further secure an additional distance to the maximum safe distance. Securing the additional distance may be set without a separate condition or, when a separate condition is met, such as when a surrounding vehicle is present around the host vehicle, may be triggered. For example, it is assumed that the safe distance from the preceding vehicle settable during ACC driving is up to 100 m, the additional distance is 20 m, and the current safe distance is maintained as 50 m. Further, it is assumed that the trigger condition is the presence of a lateral vehicle in a lane immediately next to the driving route of the vehicle. In this case, if the lateral vehicle is detected while passing through the section including the defensive driving area a3, the controller 130 may reduce the velocity of the vehicle to maintain the safe distance as 120 m.

An area including a lane diverge point and a section including a predetermined number of lanes or more may be set as a defensive driving area, similar to that described with reference to FIG. 4. In this case, the other may recklessly get in the branching lane, and thus, it may be set as a defensive driving area.

In this case, the controller 130 may change the driving lane of the vehicle when entering the defensive driving area based on the area information. When the defensive driving area includes a lane diverge point, the controller 130 may change the driving lane of the vehicle to a lane other than the lane where the other lane is branched.

According to an example, when the defensive driving area includes a lane diverge point, the controller 130 may output a lane change proposal to a lane other than the lane where the other lane is branched. In other words, even when the change of the driving lane is determined according to the defensive driving area, the controller 130 may output the lane change proposal through an in-vehicle output device rather than immediately changing the lane.

Referring to FIG. 6, a defensive driving area a4 including information about an area including a section including a predetermined number of lanes or more is illustrated. In the section including the predetermined number of lanes or more, a lateral vehicle may recklessly attempt to pass the host vehicle 1 on the left or right side, and thus, it may be set as a defensive driving area.

In this case, if it is determined that the vehicle enters the defensive driving area a4 during ACC driving, the controller 130 may control the velocity of the vehicle to maintain the maximum safe distance d1 from the preceding vehicle 2 settable in the ACC system. For example, it is assumed that the safe distance from the preceding vehicle settable during ACC driving is up to 100 m, and the current safe distance is maintained as 50 m. In this case, the controller 130 may reduce the velocity of the vehicle to maintain the safe distance as 100 m while passing through the section including the defensive driving area a4.

Alternatively, as shown in FIG. 7, if it is determined that the vehicle enters the defensive driving area a4 during ACC driving, the controller 130 may control the velocity of the vehicle to further secure an additional distance d2 to the maximum safe distance d1. Securing the additional distance may be set without any additional conditions. Alternatively, it may be triggered when a separate condition such as the presence of a surrounding vehicle around the vehicle or the recognition of the surrounding vehicle as a large vehicle is met. For example, it is assumed that the safe distance from the preceding vehicle settable during ACC driving is up to 100 m, the additional distance is 20 m, and the current safe distance is maintained as 50 m. Further, it is assumed that the trigger condition is the presence of a large vehicle in a lane immediately next to the driving route of the vehicle. In this case, if the large vehicle is detected on a side while passing through the section including the defensive driving area a4, the controller 130 may reduce the velocity of the vehicle to maintain the safe distance as 120 m.

Referring to FIG. 8, a defensive driving area a4 including information about an area including a section including a predetermined number of lanes or more is illustrated. In the section including the predetermined number of lanes or more, a lateral vehicle 3 on the side of the host vehicle 1 may drive side by side, and thus, it may be set as a defensive driving area.

The controller 130 may control the velocity of the vehicle to secure a safety space on the side of the vehicle when the surrounding vehicle is present on the side of the vehicle based on the surrounding information. In other words, as illustrated in FIG. 9, safety spaces s1 and s2 may be secured on the left and right sides, respectively, of the host vehicle 1 by reducing the velocity of the host vehicle 1.

FIG. 8 illustrates that there is only one lateral vehicle 3, but the disclosure is not limited thereto. If necessary, the trigger for the defensive driving may be set only when lateral vehicles are located on both the left and right sides of the host vehicle 1.

Accordingly, when a vehicle in adaptive cruise control driving enters a defensive driving area requiring safer driving, it is possible to control the driving of the vehicle more safely, and to prepare for a situation that may occur even when the ACC system is operating normally through active defensive driving.

A vehicle driving control method according to the disclosure may be implemented in the above-described vehicle driving control device 100. A vehicle driving control method and operations of a vehicle driving control device 100 for implementing the same are described below in detail with reference to necessary drawings, according to the disclosure. Part of the above description of the vehicle driving control device may be omitted to avoid redundancy, but the omitted part may be substantially identically applied to the vehicle driving control method.

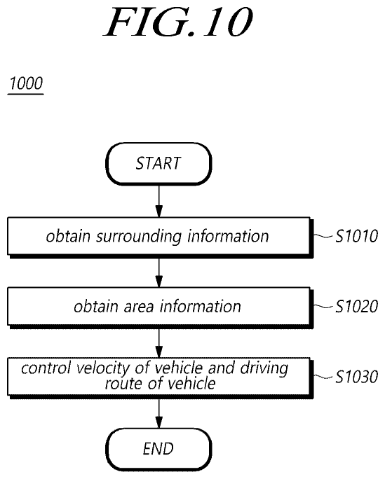

FIG. 10 is a flowchart illustrating a vehicle driving control method 1000 according to an embodiment.

Referring to FIG. 10, the vehicle driving control device may obtain information about the surroundings of the vehicle (S1010).

The vehicle driving control device may include a front/front-lateral detection sensor and a vehicle sensor. The vehicle driving control device may detect another vehicle located in the front including a preceding vehicle that is a target of ACC driving through the front/front-lateral detection sensor. Further, the vehicle driving control device may detect another vehicle located on the side of the host vehicle through the front/front-lateral detection sensor. Further, the vehicle driving control device may obtain a surrounding image such as a front side or a lateral side of the host vehicle through the front/front-lateral detection sensor.

The vehicle driving control device may obtain host vehicle information including the velocity, acceleration, torque, or the like of the host vehicle through the vehicle sensor.

Referring back to FIG. 10, the vehicle driving control device may obtain area information about a defensive driving area during adaptive cruise control (ACC) of the vehicle (S1020).

The vehicle driving control device may include a wireless device, a map data storage device, and a GPS device to obtain area information about an area requiring defensive driving when driving with the ACC system of the vehicle activated.

According to an embodiment, the area information about the defense driving area may include information about an area including a lane merge point, a lane diverge point, a tunnel entry point, a tunnel exit point, a road widen point, a road narrow point, or a section including a predetermined number of lanes or more.

According to an example, the vehicle driving control device may obtain area information through communication from an external device. For example, the vehicle driving control device may obtain the area information about the defensive driving area from communication with surrounding vehicles, infrastructure facilities on the driving route, a server of a road management entity, or the like.

According to another example, the vehicle driving control device may obtain area information based on map data and GPS information. The vehicle driving control device may obtain area information according to the location of the host vehicle based on the GPS value and the map data obtained from the GPS device.

The obtained area information about the defensive driving area may be stored in association with the map data.

According to an example, the vehicle driving control device may recognize the traffic sign from the surrounding information received from the front/front-lateral detection sensor and obtain the area information about the defensive driving area based on the traffic sign. In other words, the vehicle driving control device may recognize the traffic sign from the image around the host vehicle included in the surrounding information, and determine the type or displayed content of the traffic sign. Thereafter, the vehicle driving control device may determine whether the area to be driven corresponds to the defensive driving area according to the type or displayed content of the traffic sign.

Referring back to FIG. 10, the vehicle driving control device may control at least one of the velocity of the vehicle and the driving route of the vehicle based on at least one of the surrounding information and the area information (S1030).

The vehicle driving control device may determine whether to enter the defensive driving area when driving along the currently set driving route during ACC driving based on the area information. According to an example, when the host vehicle enters within a predetermined distance range from the defense driving area, the vehicle driving control device may determine the defense driving to control the velocity or driving route of the vehicle. Alternatively, when reaching within the predetermined time range before entering the defensive driving area considering the velocity of the vehicle, the vehicle driving control device may determine the defensive driving to control the velocity or driving route of the vehicle.

Further, the vehicle driving control device may determine the defensive driving based on the surrounding information to control the velocity of the vehicle or the driving route of the vehicle. According to an example, when the surrounding vehicle is driving on a side of the vehicle in the defensive driving area, the vehicle driving control device may control the velocity of the vehicle to secure a safety space on the side of the vehicle. Alternatively, the vehicle driving control device may determine the defensive driving when the surrounding vehicle is driving together on the side of the vehicle for a predetermined time or more, even when it is not the defensive safety area.

When determining the defensive driving, the vehicle driving control device may determine the velocity of the vehicle to be changed or the driving route of the vehicle, and control the engine control device and the brake control device to change the velocity of the vehicle or the driving route of the vehicle.

The vehicle driving control device may control the velocity of the vehicle to secure the maximum safe distance according to adaptive cruise control in the defensive driving area based on the area information. Alternatively, the vehicle driving control device may control the velocity of the vehicle to further secure an additional distance to the maximum safe distance. Further, the vehicle driving control device may change the driving lane of the vehicle when entering the defensive driving area based on the area information.

According to an example, in the case of the lane merge point, an accident may occur as another vehicle enters from the joining lane, and thus it may be set as a defensive driving area. In this case, if it is determined that the vehicle enters the defensive driving area during ACC driving, the vehicle driving control device may control the velocity of the vehicle to maintain the maximum safe distance from the preceding vehicle settable in the ACC system.

Alternatively, if it is determined that the vehicle enters the defensive driving area during ACC driving, the vehicle driving control device may control the velocity of the vehicle to further secure an additional distance to the maximum safe distance. Securing the additional distance may be set without a separate condition or, when a separate condition is met, such as when a surrounding vehicle is present around the host vehicle, may be triggered.

According to an example, in the lane merge point and the section including a predetermined number of lanes or more, an accident may occur as another vehicle enters from the merging lane, and another vehicle may recklessly get in a lane other than the joining lane, and thus, it may be set as a defensive driving area. In this case, the vehicle driving control device may change the driving lane of the vehicle when entering the defensive driving area based on the area information.

According to an example, when the defensive driving area includes a lane merge point, the vehicle driving control device may output a lane change proposal to a lane other than the lane where the other lane merges. In other words, even when the change of the driving lane is determined according to the defensive driving area, the vehicle driving control device may output the lane change proposal through an in-vehicle output device rather than immediately changing the lane.

According to an example, in an area including a lane diverge point, an accident may occur as another vehicle exits to the branching lane, and thus it may be set as a defensive driving area. In this case, if it is determined that the vehicle enters the defensive driving area during ACC driving, the vehicle driving control device may control the velocity of the vehicle to maintain the maximum safe distance from the preceding vehicle settable in the ACC system.

Alternatively, if it is determined that the vehicle enters the defensive driving area during ACC driving, the vehicle driving control device may control the velocity of the vehicle to further secure an additional distance to the maximum safe distance. Securing the additional distance may be set without a separate condition or, when a separate condition is met, such as when a surrounding vehicle is present around the host vehicle, may be triggered.

According to an example, an area including a lane diverge point and a section including a predetermined number of lanes or more may also be set as a defensive driving area. In this case, the other may recklessly get in the branching lane, and thus, it may be set as a defensive driving area. In this case, the vehicle driving control device may change the driving lane of the vehicle when entering the defensive driving area based on the area information. When the defensive driving area includes a lane diverge point, the vehicle driving control device may change the driving lane of the vehicle to a lane other than the lane where the other lane is branched.

According to an example, when the defensive driving area includes a lane diverge point, the vehicle driving control device may output a lane change proposal to a lane other than the lane where the other lane is branched. In other words, even when the change of the driving lane is determined according to the defensive driving area, the vehicle driving control device may output the lane change proposal through an in-vehicle output device rather than immediately changing the lane.

According to an example, in the section including the predetermined number of lanes or more, a lateral vehicle may recklessly attempt to pass the host vehicle on the left or right side, and thus, it may be set as a defensive driving area. In this case, if it is determined that the vehicle enters the defensive driving area during ACC driving, the vehicle driving control device may control the velocity of the vehicle to maintain the maximum safe distance from the preceding vehicle settable in the ACC system.

Alternatively, if it is determined that the vehicle enters the defensive driving area during ACC driving, the vehicle driving control device may control the velocity of the vehicle to further secure an additional distance to the maximum safe distance. Securing the additional distance may be set without any additional conditions. Alternatively, it may be triggered when a separate condition such as the presence of a surrounding vehicle around the vehicle or the recognition of the surrounding vehicle as a large vehicle is met.

According to an example, in the section including the predetermined number of lanes or more, a lateral vehicle 3 on the side of the host vehicle 1 may drive side by side, and thus, it may be set as a defensive driving area. In this case, the vehicle driving control device may control the velocity of the vehicle to secure a safety space on the side of the vehicle when the surrounding vehicle is present on the side of the vehicle based on the surrounding information.

Accordingly, when a vehicle in adaptive cruise control driving enters a defensive driving area requiring safer driving, it is possible to control the driving of the vehicle more safely, and to prepare for a situation that may occur even when the ACC system is operating normally through active defensive driving.

The above-described embodiments of the present disclosure may be implemented in code that a computer may read out of a recording medium. The computer-readable recording medium includes all types of recording devices storing data readable by a computer system. Examples of the computer-readable recording medium include hard disk drives (HDDs), solid state disks (SSDs), silicon disk drives (SDDs), read-only memories (ROMs), random access memories (RAMs), CD-ROMs, magnetic tapes, floppy disks, or optical data storage devices.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed:

1. A vehicle driving control device, comprising:
a plurality of sensors configured to obtain surrounding information about a vehicle;
an information obtainer configured to obtain area information about a defensive driving area during adaptive cruise control (ACC) of the vehicle; and
a controller configured to control at least one of a velocity of the vehicle and a driving route of the vehicle based on at least one of the surrounding information and the area information.

2. The vehicle driving control device of claim 1, wherein the area information includes information about an area including a lane merge point, a lane diverge point, a tunnel entry point, a tunnel exit point, a road widen point, a road narrow point, or a section including a predetermined number of lanes or more.

3. The vehicle driving control device of claim 1, wherein the controller controls the velocity of the vehicle to secure a maximum safe distance according to adaptive cruise control in the defensive driving area based on the area information.

4. The vehicle driving control device of claim 3, wherein the controller controls the velocity of the vehicle to further secure an additional distance to the maximum safe distance.

5. The vehicle driving control device of claim 3, wherein the controller controls the velocity of the vehicle to secure a safety space on a side of the vehicle when a surrounding vehicle is present on the side of the vehicle, based on the surrounding information.

6. The vehicle driving control device of claim 1, wherein the controller changes a driving lane of the vehicle when entering the defensive driving area based on the area information.

7. The vehicle driving control device of claim 6, wherein the controller changes the driving lane of the vehicle to a lane other than a lane joined by another lane or a lane where another lane is branched when the defensive driving area includes a lane merge point or a lane diverge point.

8. The vehicle driving control device of claim 1, wherein the controller outputs a proposal for a lane change to a lane other than a lane joined by another lane or a lane where another lane is branched when the defensive driving area includes a lane merge point or a lane diverge point.

9. The vehicle driving control device of claim 1, wherein the information obtainer obtains the area information through communication from an external device or obtains the area information based on map data or GPS information.

10. The vehicle driving control device of claim 1, wherein the controller recognizes a traffic sign from the surrounding information and obtains the area information based on the traffic sign.

11. A vehicle driving control method, comprising:
obtaining surrounding information about a vehicle;
obtaining area information about a defensive driving area during adaptive cruise control (ACC) of the vehicle; and
controlling at least one of a velocity of the vehicle and a driving route of the vehicle based on at least one of the surrounding information and the area information.

12. The vehicle driving control method of claim 11, wherein the area information includes information about an area including a lane merge point, a lane diverge point, a tunnel entry point, a tunnel exit point, a road widen point, a road narrow point, or a section including a predetermined number of lanes or more.

13. The vehicle driving control method of claim 11, wherein controlling the at least one of the velocity of the vehicle and the driving route of the vehicle controls the velocity of the vehicle to secure a maximum safe distance according to adaptive cruise control in the defensive driving area based on the area information.

14. The vehicle driving control method of claim 13, wherein controlling the at least one of the velocity of the vehicle and the driving route of the vehicle controls the velocity of the vehicle to further secure an additional distance to the maximum safe distance.

15. The vehicle driving control method of claim 13, wherein controlling the at least one of the velocity of the vehicle and the driving route of the vehicle controls the velocity of the vehicle to secure a safety space on a side of the vehicle when a surrounding vehicle is present on the side of the vehicle, based on the surrounding information.

16. The vehicle driving control method of claim 11, wherein controlling the at least one of the velocity of the vehicle and the driving route of the vehicle changes a driving lane of the vehicle when entering the defensive driving area based on the area information.

17. The vehicle driving control method of claim 16, wherein controlling the at least one of the velocity of the vehicle and the driving route of the vehicle changes the driving lane of the vehicle to a lane other than a lane joined by another lane or a lane where another lane is branched when the defensive driving area includes a lane merge point or a lane diverge point.

18. The vehicle driving control method of claim 11, further comprising outputting a proposal for a lane change to a lane other than a lane joined by another lane or a lane where another lane is branched when the defensive driving area includes a lane merge point or a lane diverge point.

19. The vehicle driving control method of claim 11, wherein the area information is obtained through communication from an external device or is obtained based on map data or GPS information.

20. The vehicle driving control method of claim 11, wherein the area information is obtained based on a traffic sign recognized from the surrounding information.
